(19) United States
(12) Patent Application Publication
(10) Pub. No.: US 2025/0270033 A1
(43) Pub. Date: Aug. 28, 2025

(54) Wall Mounted Waste Bag Holder

(71) Applicant: PAUL Vizzio, New York, NY (US)

(72) Inventor: PAUL Vizzio, New York, NY (US)

(21) Appl. No.: 19/060,643

(22) Filed: Feb. 22, 2025

Related U.S. Application Data
(60) Provisional application No. 63/557,752, filed on Feb. 26, 2024.

(51) Int. Cl. B65F 1/00; B65D 83/08

(52) U.S. Cl. CPC B65F 1/0013; B65D 83/0805; B65F 2240/136

(57) ABSTRACT

An apparatus that securely attaches to a wall or other flat surface, which allows dog waste bag dispensers to be attached and removed. The apparatus includes a plurality of joining features allowing different sized waste bag dispensers to be attached. The apparatus allows a user to securely mount their waste bag dispenser in a convenient spot, while allowing flexibility to remove the waste bag dispenser while cleaning up pet waste.

### CROSS REFERENCE TO RELATED APPLICATIONS

This application claims the benefit of U.S. Provisional Application No. 63/557,752, filed on Feb. 26, 2024. The entire teachings of the above applications are incorporated herein by reference.

### FIELD OF THE INVENTION

The present invention relates generally to the field of dog waste collection, and more particularly to methods and systems for dog waste bag dispensing.

### BACKGROUND

When walking one's pet it is common to bring a device that holds pre-rolled waste bags, such as shown in U.S. Pat. No. 7,850,039B1, in order to pick up one's pet's excrement while on a walk.

In other cases, one may leave the device at home and just bring dog waste bags with them.

The state of the current art is similar to that of U.S. Pat. No. 8,113,381B2, wherein small lightweight devices are added to one's existing leash that hold a roll of waste bags.

For home bag dispensing, the current art has products which rigidly mount to the wall and dispense pre-rolled waste bags.

There is no solution that offers both on leash and at home bag dispensing.

Therefore, there needs to be a solution that allows for on leash bag dispensing as well as at home bag dispensing, while remaining small, light, and convenient.

### SUMMARY OF THE INVENTION

The present invention can provide an apparatus which affixes to a wall through the use of double-sided tape. The apparatus can securely hold a dog waste bag dispenser while allowing use of the dispenser. The apparatus can allow the dispenser to be removed from the apparatus allowing the dispenser to be taken with a user on their walk.

In some embodiments the apparatus can be affixed to the wall through screws or nails through mounting holes in the apparatus.

In some embodiments the dispenser can be slid into the apparatus through a slot in the shape of the dispenser. This can be shaped uniquely to different dispensers of different sizes and materials.

In some embodiments the apparatus and dispenser can be held together through snap features.

In some embodiments the apparatus and dispenser can be held together through magnets, tape, or other adhesive type mounts known to those in the art.

In some embodiments, the parts can be made of rigid materials such as plastics, metals, and composites.

In some embodiments, the parts can be made of a combination of soft and rigid materials such as fabrics, cloth, silicone, and rubber.

In some embodiments, the apparatus can hold smaller dispensers.

In some embodiments, the apparatus can hold larger dispensers.

In some embodiments, the apparatus can hold soft sided dispensers.

### BRIEF DESCRIPTION OF DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is an isometric view of an embodiment of the apparatus fully together and installed on a wall.

FIG. 2 is an exploded view of an embodiment of the apparatus.

### A DETAILED DESCRIPTION

Details of some embodiments of the apparatus in the present invention are described below.

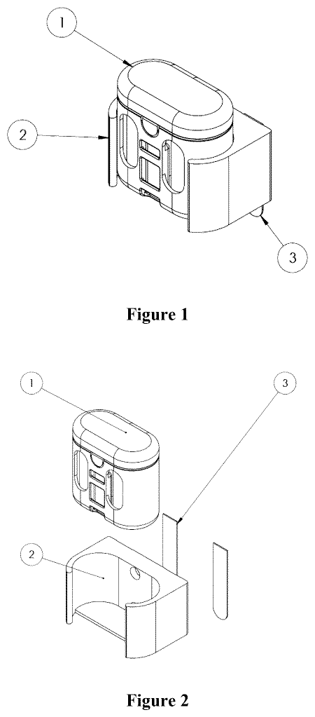

Referring to FIG. 1, in some embodiments of the apparatus the main holder piece (2) may accept a dog waste bag dispenser (1) through the use of cutouts that allows the dispenser to slide in and be securely held.

Referring to FIG. 2, in some embodiments of the apparatus the main holder piece (2) may be attached to a wall through the use of double sided tape (3).

What is claimed is:

1. A dog waste bag dispenser holding device, comprising:
A plurality of joinery features allowing it to join and separate with a dog waste bag dispenser;
Features to securely hold it to a wall or other flat surface.
